(19) United States
(12) Patent Application Publication
(10) Pub. No.: US 2024/0320576 A1
(43) Pub. Date: Sep. 26, 2024

(54) OPERATION PLAN CREATION APPARATUS AND OPERATION PLAN CREATION METHOD

(71) Applicant: Mitsubishi Electric Corporation, Tokyo (JP)

(72) Inventors: Shuhei FUJITA, Tokyo (JP); Atsuko AOKI, Tokyo (JP); Ai KOSHI, Tokyo (JP); Yosuke NAKAYAMA, Tokyo (JP)

(73) Assignee: Mitsubishi Electric Corporation, Tokyo (JP)

(21) Appl. No.: 18/578,724

(22) PCT Filed: Jul. 20, 2021
(86) PCT No.: PCT/JP2021/027063

§ 371 Date: Jan. 12, 2024

(51) Int. Cl. G06Q 10/0631

(52) U.S. Cl. CPC G06Q 10/063114; G06Q 10/063116

(57) ABSTRACT

The object is to provide a technology for enabling creation of an appropriate operation plan in consideration of states of operators at work time and at non-work time. An obtaining unit obtains at least one of biological information or living behavior information of an operator at work time and at non-work time, attribute information on the operator, and production planning on the operator, a load estimator estimates a mental load amount on the operator, based on the at least one of the biological information or the living behavior information, and an operation plan creation unit creates an operation plan of the operator, based on the attribute information, the production planning, and the mental load amount.

### TECHNICAL FIELD

The present disclosure relates to an operation plan creation apparatus and an operation plan creation method.

### BACKGROUND ART

In recent years, inexpensive wearable devices can continuously obtain biological information such as a heart rate or a pulse rate of a person with high precision. Furthermore, systems each estimating a mental load such as stresses from the biological information of an operator and managing the safety and the health of the operator based on a result of the estimation have been commercially available. The biological information has been obtained from the wearable device. Since these systems need not make the operators conscious about being measured, the operators can be managed in a more natural state. The systems are effective as a method for managing operators, particularly at worksites with wider floor spaces and a plurality of persons at one time such as factories.

Patent Document 1 proposes an operation plan creator that estimates fatigue of a working operator using biological information of the operator and assigns an operation with a small increment of fatigue to an operator with high fatigue.

### PRIOR ART DOCUMENT

### Patent Document

Patent Document 1: Japanese Patent Application Laid-Open No. 2018-47980

### Problem to be Solved by the Invention

The technology described in Patent Document 1, however, does not consider the life and behaviors of the operator at non-work time. This may cause an operator with low fatigue by chance at work time to be assigned an operation with a large increment of fatigue, despite the fact that the fatigue of the operator at non-work time is high. As a result, problems of an increase in a load of the operator and a decrease in the working efficiency arise.

The present disclosure has been made in view of the problems, and has an object of providing a technology for enabling creation of an appropriate operation plan in consideration of states of operators at work time and at non-work time.

### Means to Solve the Problem

An operation plan creation apparatus according to the present disclosure includes: an obtaining unit to obtain at least one of biological information or living behavior information of an operator at work time and at non-work time, attribute information on the operator, and production planning on the operator; a load estimator to estimate a mental load amount on the operator, based on the at least one of the biological information or the living behavior information; and an operation plan creation unit to create an operation plan of the operator, based on the attribute information, the production planning, and the mental load amount.

### Effects of the Invention

The present disclosure allows estimation of a mental load amount on an operator, based on at least one of biological information or living behavior information on an operator at work time and at non-work time, and creation of an operation plan of the operator, based on attribute information, production planning, and the mental load amount. Such a structure enables creation of an appropriate operation plan in consideration of states of the operator at work time and at non-work time.

The object, features, aspects, and advantages of the present disclosure will become more apparent from the following detailed description and the accompanying drawings.

### BRIEF DESCRIPTION OF DRAWINGS

FIG. 1 is a block diagram illustrating a configuration of an operation plan creation apparatus according to Embodiment 1.

FIG. 2 illustrates an example of biological information.

FIG. 3 illustrates an example of living behavior information.

FIG. 4 illustrates an example of attribute information.

FIG. 5 illustrates an example master schedule for production planning.

FIG. 6 illustrates an example intermediate schedule for the production planning.

FIG. 7 illustrates an example detailed schedule for the production planning.

FIG. 8 is a flowchart illustrating a procedure performed by a load estimator according to Embodiment 1.

FIG. 9 illustrates processes of the load estimator according to Embodiment 1.

FIG. 10 illustrates the processes of the load estimator according to Embodiment 1.

FIG. 11 illustrates the processes of the load estimator according to Embodiment 1.

FIG. 12 illustrates processes of a temporary operation plan creation unit according to Embodiment 1.

FIG. 13 illustrates processes of a simulator according to Embodiment 1.

FIG. 14 illustrates the processes of the simulator according to Embodiment 1.

FIG. 15 is a block diagram illustrating a hardware configuration of the operation plan creation apparatus according to Embodiment 1.

FIG. 16 is a block diagram illustrating a network configuration of the operation plan creation apparatus according to Embodiment 1.

FIG. 17 is a block diagram illustrating a configuration of an operation plan creation apparatus according to Embodiment 2.

FIG. 18 is a flowchart illustrating a procedure of a living behavior information estimator according to Embodiment 2.

FIG. 19 illustrates processes of the living behavior information estimator according to Embodiment 2.

FIG. 20 illustrates processes of a simulator according to Embodiment 3.

FIG. 21 illustrates the processes of the simulator according to Embodiment 3.

### DESCRIPTION OF EMBODIMENTS

### Embodiment 1

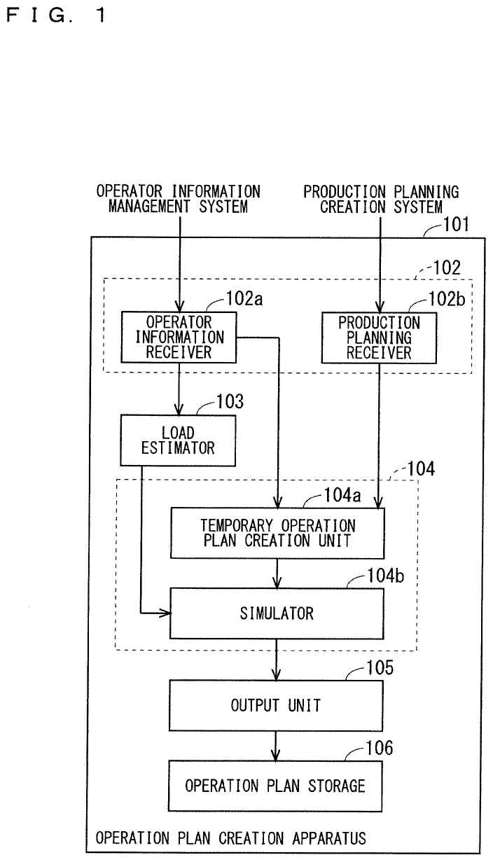

FIG. 1 is a block diagram illustrating a configuration of an operation plan creation apparatus 101 according to Embodiment 1. The operation plan creation apparatus in FIG. 1 includes an obtaining unit 102, a load estimator 103, an operation plan creation unit 104, an output unit 105, and an operation plan storage 106.

### [Obtaining Unit 102]

The obtaining unit 102 includes an operator information receiver 102a and a production planning receiver 102b. The obtaining unit 102 with such a configuration obtains biological information, living behavior information, attribute information, and production planning. The operator information receiver 102a and the production planning receiver 102b of the obtaining unit 102 will be described hereinafter.

### Operator Information Receiver 102a

The operator information receiver 102a obtains, from an operator information management system, the biological information and the living behavior information of an operator at work time and at non-work time, and the attribute information of the operator. A time period during which the biological information and the living behavior information are obtained can be arbitrarily set. The operator is, for example, a person who performs an operation at a production site such as a factory, a plant, or a construction site. The work time is, for example, a time during which the operator performs the operation at the production site, whereas the non-work time is, for example, a time other than the work time. The following will describe an example where the operator is an operator who works at a factory.

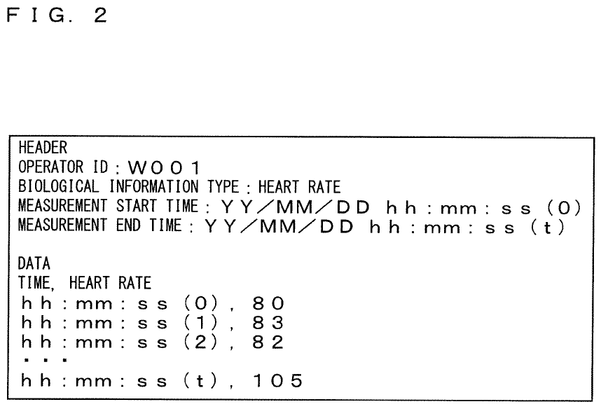

FIG. 2 illustrates an example of the biological information obtained by the operator information receiver 102a. Examples of the biological information include time-series data of physiological signals indicating a heart rate (i.e., heart rate variability), a cardiac cycle, a pulse rate, a blink count, an electrooculogram potential, a line of sight, a body surface temperature, a deep body correspondence, a blood pressure, a respiration rate, a sweat rate, a skin potential, and a myoelectric potential that are obtained by sensing instruments such as a wearable device, a radar sensor, and a non-contact sensor. The biological information may include time-series data of signals on physical motions such as an acceleration and a three-dimensional acceleration. The biological information including time-series data of physiological signals indicating heart rates that are obtained by a wearable device will be hereinafter described as example biological information.

The biological information includes, for example, an operator ID unique to each operator, a biological information type indicating a type of the biological information, a measurement start date indicating a start date of the measurement, a measurement end time indicating an end time of the measurement, and numerical information on measured values of the biological information. Although the measured values are integers in the example of FIG. 2, they may be actual numbers. By which numeric value the measured values are represented is determined depending on the specification of the wearable device. The time at which each of the measured values has been obtained should be identified from time information of the measured value. When a period in which the wearable device obtains the biological information from the operator corresponds to a certain value, describing the period information in a header portion enables identification of the time of each of the measured values. Thus, the time information of the biological information can be almost omitted.

In the following description, for example, an operator with an operator ID “W001” may be described as an operator W001.

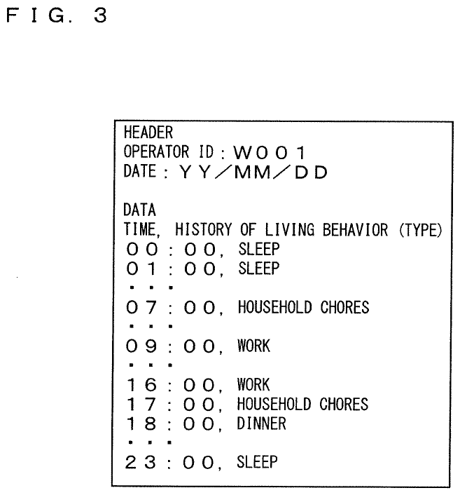

FIG. 3 illustrates an example of the living behavior information obtained by the operator information receiver 102a. The living behavior information is information on histories (i.e., types) of living behaviors per day, and is information to be registered by the operator through electronic equipment such as a smart phone, a mobile phone, and a PC. The living behavior information includes, for example, an operator ID, a date, times, and a history of a living behavior for each of the times. Although the time unit for dividing the histories of the living behaviors is 1 hour in the example of FIG. 3, the time unit may be 30 minutes, 2 hours, or any time. The histories of a plurality of living behaviors may be recorded in a time unit. For example, not only “household chores” but also “breakfast” and “parenting” may be recorded as the histories of a plurality of living behaviors at the time “7:00”.

Since registering the histories of living behaviors of a whole day by its own operator requires enormous efforts . . . for example, the history behavior histories of living behaviors only during the times “08:00 to 20:00” may be registered. Not characters such as “sleep” and “household chores” but the numbers and letters of the alphabet associated with the living behavior information in advance may be registered as the histories of living behaviors to be registered. For example, “0” or “A” instead of “sleep” and “1” or “B” instead of “household chores” may be registered.

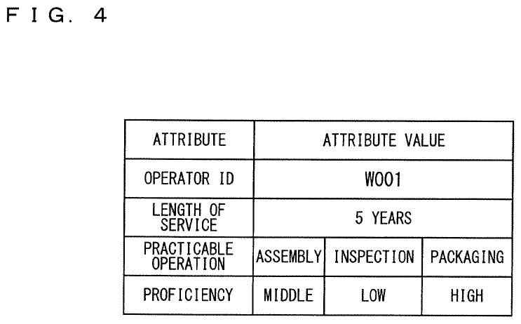

FIG. 4 illustrates an example of the attribute information on an operator which is obtained by the operator information receiver 102a. The attribute information includes, for example, an operator ID for uniquely identifying an operator, and operation information on the operator. The attribute information includes, for example, the length of service, practicable operations, and the proficiency as the operation information on the operator. In the example of FIG. 4, “assembly”, “inspection”, and “packaging” are set as practicable operations of the operator W001. The operations are associated with the respective proficiencies, and managed. The number of the practicable operations need not be always plural. Although the proficiencies are defined by three levels of “high”, “middle”, and “low” in the example of FIG. 4, the proficiencies may be defined by any parameters allowing comparative evaluation, such as the numbers “1 to 10”.

[Production Planning Receiver 102b]

The production planning receiver 102b in FIG. 1 obtains, from a production planning creation system, information on production planning on operators which has been created by the production planning creation system. Japanese Industrial Standards (JIS) defines production planning as “planning on production volumes and production periods”. The production planning is divided into three schedules, namely, a master schedule, an intermediate schedule, and a detailed schedule. The master schedule for the production planning is defined as “long-term production planning as a master schedule which determines a monthly production volume”. The intermediate schedule for the production planning is defined as “determining production plans separately for departments based on the master schedule for the production planning”. The detailed schedule for the production planning is defined as “determining daily operation plans”.

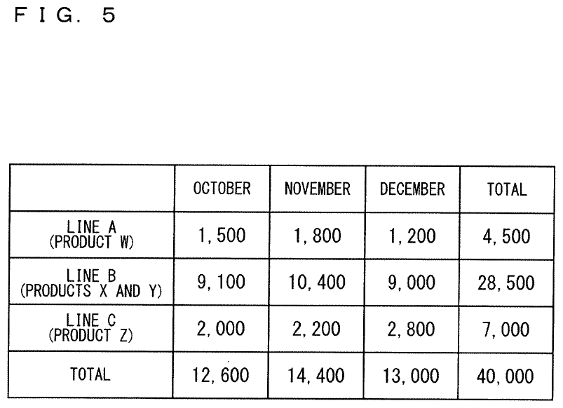

FIG. 5 illustrates an example master schedule for the production planning. The master schedule for the production planning includes information on production volumes for respective lines which are separately planned, for example, per month in three months. Although the example of FIG. 5 illustrates a plan of producing a plurality of products in three lines (line A, line B, and line C), the plan is not limited to this but at least one product should be produced in at least one line.

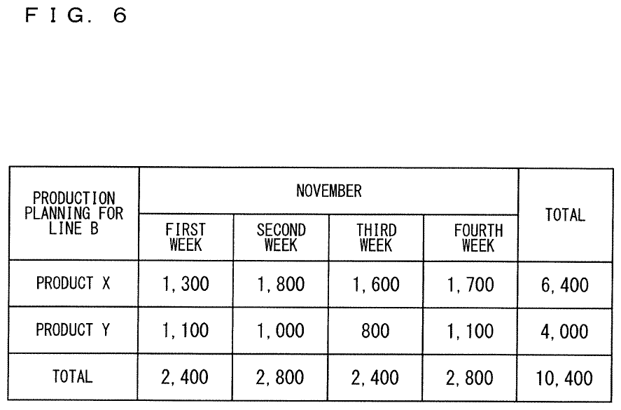

FIG. 6 illustrates an example intermediate schedule for the production planning. The intermediate schedule for the production planning includes information on production volumes for respective products which are separately planned, for example, per week in one month. The example of FIG. 6 illustrates a production volume for each product per week which is planned for the line B in November in FIG. 5.

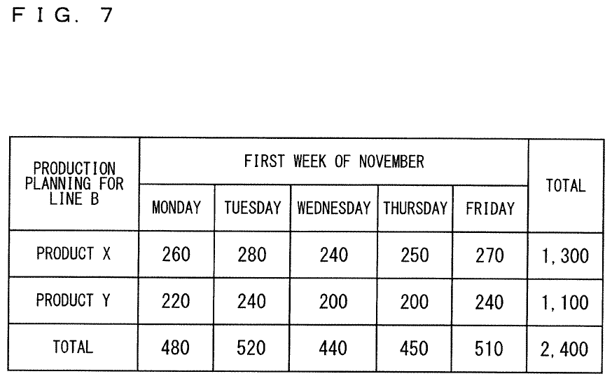

FIG. 7 illustrates an example detailed schedule for the production planning. The detailed schedule for the production planning includes information on production volumes for respective products which are separately planned, for example, per day of one week. The example of FIG. 7 illustrates a production volume for each product per day of the week which is planned for the line B in the first week of November in FIG. 6.

### [Load Estimator 103]

The load estimator 103 in FIG. 1 estimates a mental load amount that is an amount of the mental load on the operator, based on the biological information and the living behavior information obtained by the operator information receiver 102a. Here, examples of the mental load include states of stresses, tension, and depression. The following will describe an example where a mental load is stresses and a mental load amount is a stress level numerically representing a degree of the stresses.

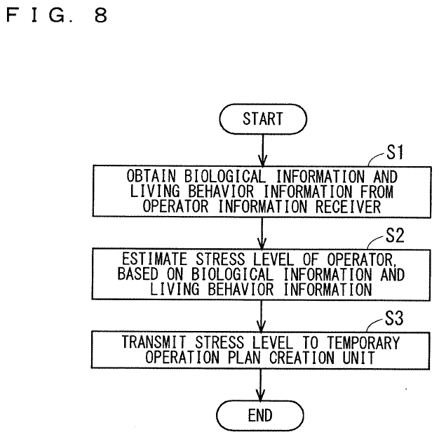

FIG. 8 is a flowchart illustrating a procedure for estimating stresses by the load estimator 103.

First, in Step S1, the load estimator 103 obtains the biological information and the living behavior information from the operator information receiver 102a. The time period during which the biological information and the living behavior information are obtained can be arbitrarily set. For example, if the period is set to a period for the past three months from the time of creating the planning, the load estimator 103 obtains the biological information and the living behavior information during the period.

In Step S2, the load estimator 103 estimates a stress level of an operator, based on the biological information and the living behavior information. The stress level can be understood by subjective evaluation or objective evaluation. The subjective evaluation is a method using answers to dedicated questions, whereas the objective evaluation is a physiological method using the biological information.

The load estimator 103 may estimate a stress level based on the heart rate variability, respiration, or the electrodermal activity by sweating which represents the activity of the autonomic nerve, as a method of estimating a stress level through a physiological method. The following will describe an example where the load estimator 103 estimates a stress level based on the heart rate variability.

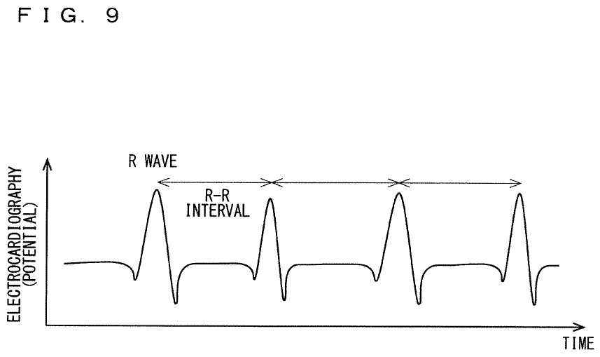

As illustrated in FIG. 9, the heart rate variability is variability in R-R interval that is an interval between peaks (R waves) of heart beats. An analysis on the R-R interval enables evaluation of a stress level. In view of this, the load estimator 103 estimates a stress level by comparing the R-R interval with a predefined threshold according to Embodiment 1.

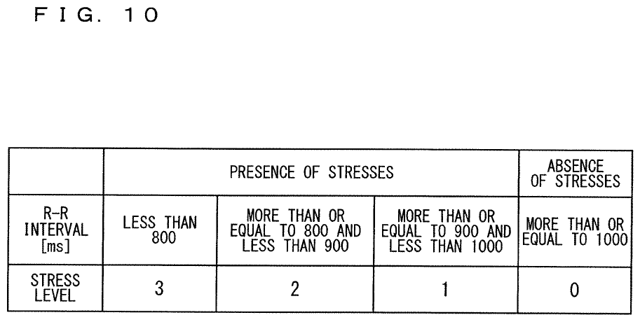

As illustrated in FIG. 10, the load estimator 103 may estimate a stress level for one day when the R-R interval is less than 1000 to be “the presence of stresses” (i.e., the stress level 1 or higher), and estimate a stress level for one day when the R-R interval is more than or equal to 1000 to be “the absence of stresses” (i.e., the stress level 0). The load estimator 103 may further divide the stress level “the presence of stresses” into levels, and estimate a stress level for one day when the R-R interval is more than or equal to 900 and less than 1000, a stress level for one day when the R-R interval is more than or equal to 800 and less than 900, and a stress level for one day when the R-R interval is less than 800 to be a stress level 1, a stress level 2, and a stress level 3, respectively.

The state of stresses may temporarily increase by chance for some reason in daily living behaviors. Here, the load estimator 103 may determine a stress level for one day when the R-R interval is less than 1000 for half a day or longer, that is, for 12 hours or longer in total to be “the presence of stresses”. Furthermore, the load estimator 103 may estimate a stress level a plurality of times, based on R-R intervals at a plurality of times in one day, and estimate the stress level estimated the highest number of times from among the stress levels estimated the plurality of times to be a stress level for the one day. This enables the load estimator 103 to determine a stress level for one day when the R-R interval is less than 1000 only for an aggregate of one hour within the one day to be “the absence of stresses”. Thus, the load estimator 103 can more accurately estimate the stress level.

The load estimator 103 may estimate stress levels by not applying a common threshold to R-R intervals of all the operators but applying a threshold individually defined for each of the operators. The load estimator 103 may calculate an individual threshold for each of the operators, based on an average and a statistic of a median of heart rate variabilities of the operator in the past three months.

The heart rate variabilities to be used for estimating a stress level are desirably measured in a state where the operator stays rested as much as possible. Thus, when determining the presence of a time period during which the operator has performed, for example, an operation and a movement with a large physical motion, based on the living behavior information, the load estimator 103 may estimate a stress level without using the heart rate variability during the time period. For example, if the operator has jogged for one hour, the load estimator 103 may determine a stress level for one day when the R-R interval is less than 1000 for half the remaining 23 hours or longer, that is, for 11.5 hours or longer in total to be “the presence of stresses”.

Furthermore, in the presence of a time period during which the heart rate variability of the biological information to be used for estimating a stress level is lost for some reason, the load estimator 103 may estimate the stress level based on the heart rate variability and the living behavior information during the time period. Here, how each operator feels stresses normally differs depending on the type of their living behavior. In view of this, the load estimator 103 may associate a type of a living behavior that particularly makes each operator feel stresses with any one of the stress levels 0 to 3 in advance, and estimate a stress level by comparing the associated type with a type of a living behavior indicated by the actual living behavior information. For example, the attribute information on the operator (see FIG. 4) may include the type of the living behavior that particularly makes each operator feel stresses.

Assume a case, for example, where the actual living behavior information at “18:00 to 19:00” of an operator who categorizes “household chores” as the type of the living behavior that particularly makes the operator feel stresses indicates the “household chores” and the heart rate variability during the time period is lost. In this case, the load estimator 103 may estimate the stress level during the time period to be a stress level associated with “household chores”. As an extension of the foregoing, the load estimator 103 may estimate a stress level of the operator, based on only one of the biological information and the living behavior information.

The load estimator 103 according to Embodiment 1 estimates a stress level during a period identical in length to the production planning. For example, the load estimator 103 calculates a stress level per three months if the period of the production planning is three months. For example, the load estimator 103 first calculates a sum of stress levels of each month from the stress levels in the past three months, divides the sum by the number of days during the period (e.g., 30 days) to calculate an average (drop the fractional portion of the number), and calculates a monthly stress level.

Next, when the monthly stress level increases or does not vary for three consecutive months, the load estimator 103 determines a monthly stress level for the latest one month to be a stress level per three months. When the monthly stress level does not increase and varies for three consecutive months, the load estimator 103 determines an average of monthly stress levels for the three months (drops the fractional portion of the number) to be a stress level per three months.

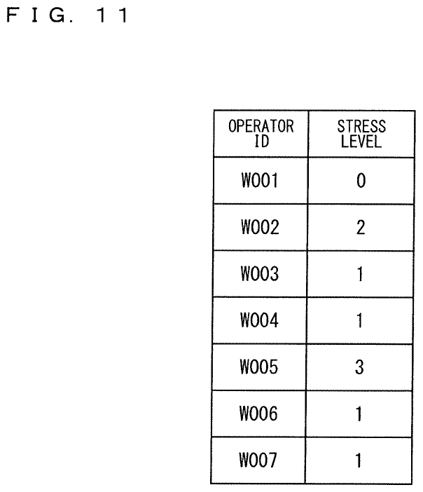

In Step S3 of FIG. 8, the load estimator 103 transmits, to a temporary operation plan creation unit 104a, the stress level per three months which has been estimated for each of the operators as illustrated in FIG. 11.

### [Operation Plan Creation Unit 104]

The operation plan creation unit 104 includes the temporary operation plan creation unit 104a and a simulator 104b. The operation plan creation unit 104 with such a configuration creates an operation plan of each operator, based on the attribute information, the production planning, and the stress level estimated by the load estimator 103. The temporary operation plan creation unit 104a and the simulator 104b of the operation plan creation unit 104 will be described hereinafter.

[Temporary Operation Plan Creation Unit 104a]

The temporary operation plan creation unit 104a creates a temporary operation plan of each operator, based on the attribute information of the operator and the production planning. The temporary operation plan is a temporary operation plan to be used in the operation plan creation unit 104. The operation plan is a plan on assignment of operations for the production planning to operators for realizing the production planning in a certain time period. The following will describe a case where a time period during which the production planning is created (i.e., a planning target period) is one month.

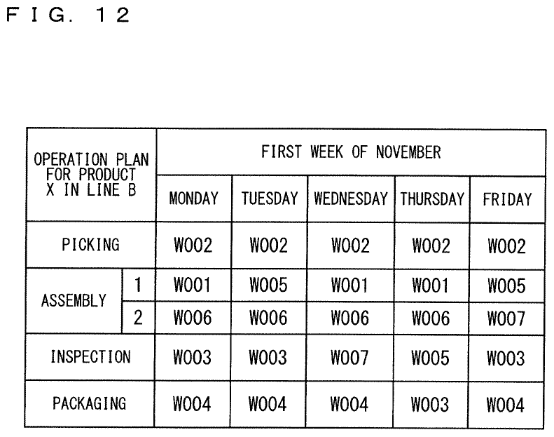

FIG. 12 illustrates an example temporary operation plan created by the temporary operation plan creation unit 104a. FIG. 12 illustrates the example temporary operation plan from Monday through Friday in the first week of November in the line B. The line B includes “picking”, “assembly”, “inspection”, and “packaging” as operations, and “inspection” is planned as being performed by two operators. The temporary operation plan creation unit 104a assigns operations of the production planning to operators from among operators who can report to work each day of a week, based on pieces of the attribute information of the operators to create a temporary operation plan. For example, the temporary operation plan creation unit 104a preferentially assigns high proficiency operations from among practicable operations to be performed by the operators who can report to work to operations planned in the production planning to create the temporary operation plan. The example of FIG. 12 reflects that the proficiency of an operator W002 in the operation “picking” is high, the proficiency of an operator W004 in the operation “packaging” is high, and the proficiency of an operator W005 in the operation “assembly” is lower than that of the operator W001.

### [Simulator]

The simulator 104b calculates transitions in cumulative amounts of stress levels, based on the stress levels estimated by the load estimator 103 and the temporary operation plan created by the temporary operation plan creation unit 104a. The simulator 104b according to Embodiment 1 calculates the transitions in cumulative amounts of stress levels, based on the stress levels and an increment of each of the stress levels that are associated in advance with the operations planned in the temporary operation plan.

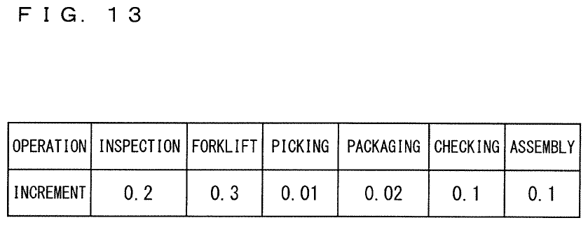

FIG. 13 illustrates example increments of the stress levels that are associated in advance with the operations planned in the temporary operation plan. The increments of the stress levels each indicate a stress level to be increased by performing the operation by the operator for one day. The example of FIG. 13 also illustrates operations such as “forklift” and “checking” that are included in lines other than the line B in FIG. 12.

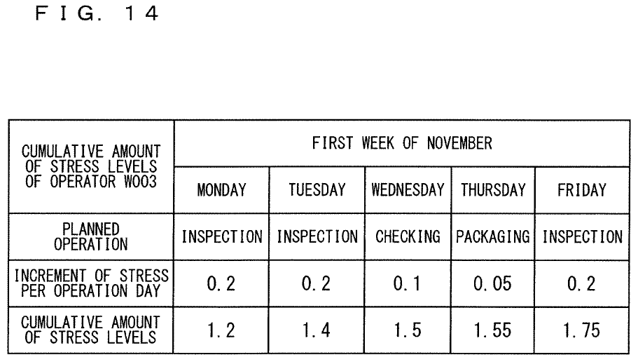

FIG. 14 illustrates example transitions in cumulative amounts of stress levels when an operator has performed the operations according to the temporary operation plan. Specifically, FIG. 14 illustrates example transitions in cumulative amounts of stress levels when the operator W003 has performed the operations according to the temporary operation plan in FIG. 12.

The simulator 104b adds an increment “0.2” associated in advance with the operation “inspection” on Monday to the stress level “1” of the operator W003 which has been estimated by the load estimator 103 in FIG. 11 to calculate a cumulative amount “1.2” of stress levels on Monday. Furthermore, the simulator 104b adds an increment “0.2” associated in advance with the operation “inspection” on Tuesday to the cumulative amount “1.2” of the stress levels on Monday to calculate a cumulative amount “1.4” of stress levels on Tuesday. The simulator 104b calculates transitions in cumulative amounts of stress levels, by similarly calculating the cumulative amounts of stress levels from Wednesday through Friday. The simulator 104b performs a simulation for calculating transitions in cumulative amounts of stress levels for each of the operators.

The simulator 104b according to Embodiment 1 changes the temporary operation plan based on the transitions in cumulative amounts of stress levels to create an operation plan. For example, when the cumulative amounts in the transitions of one of the operators are higher than or equal to a first threshold that is a threshold, the simulator 104b changes the temporary operation plan (i.e., changes the assignment of operations to the operators) to create an operation plan. When the cumulative amounts in the transitions of the operator is not higher than or equal to the first threshold, the simulator 104b finalizes the temporary operation plan as an operation plan. The first threshold may be changed based on the time period for the temporary operation plan created by the temporary operation plan creation unit 104a.

When the cumulative amounts in the transitions of one of the operators are higher than or equal to the first threshold, the simulator 104b according to Embodiment 1 sets a time period from when the cumulative amounts in the transitions are higher than or equal to a second threshold to the end of the temporary operation plan as a change target period. Then, the simulator 104b changes the temporary operation plan during the change target period to create an operation plan. The second threshold is set to, for example, a value obtained by multiplying the first threshold by a constant lower than or equal to 1, that is, a value lower than the first threshold. For example, when the first threshold is set to “2”, the second threshold is set to “1.5” (75% of the first threshold).

When changing the temporary operation plan, the simulator 104b sets an operation with a relatively small increment of a stress level in FIG. 13 from among the operations that can be performed by operators whose cumulative amounts are higher than or equal to the first threshold to an operation of the operator during the change target period. Then, the simulator 104b assigns the remaining operations during the change target period to the remaining operators, based on the pieces of attribute information on the remaining operators. Next, the simulator 104b performs the simulation for calculating transitions in cumulative amounts of stress levels for each of the operators again on the changed temporary operation plan.

In the absence of an operator whose cumulative amounts are higher than or equal to the first threshold through the re-simulation, the simulator 104b finalizes the temporary operation plan at this time as an operation plan. In the presence of the operator whose cumulative amounts are higher than or equal to the first threshold at this time, the simulator 104b assigns the operations and performs the simulation again in the aforementioned procedure. As a result of preferentially assigning operations with small increments of stress levels to the operators whose cumulative amounts of stress levels are higher than or equal to the first threshold, there is sometimes no operator who can perform the remaining operations. In this case, the simulator 104b may assign operations with large increments of stress levels in order from operators with longer lengths of service based on, for example, the respective pieces of attribute information.

In the presence of a single operator whose cumulative amounts of stress levels are higher than or equal to the first threshold as a result of the aforementioned processes, the simulator 104b may change assignment of the operations so that increments of cumulative amounts of stress levels of each operator are the smallest.

Although an increment of each of the stress levels that are associated in advance with the operations planned in the temporary operation plan (see FIG. 13) is common to all the operators in the aforementioned examples, the increments of the stress levels may be defined in advance for each of the operators. Generally, each operator differs in magnitude of stresses that the operator feels through performing an operation. This structure enables the simulator 104b to appropriately calculate transitions of cumulative amounts of stress levels. Furthermore, when data on increments of stress levels for respective operations is fully stored, the simulator 104b may calculate a machine learning model using the data as learning data and calculate increments of stresses using this model. Changes in the temporary operation plan by the simulator 104b are not limited to the aforementioned cases.

### [Output Unit 105 and Operation Plan Storage 106]

The output unit 105 outputs the operation plan created by the operation plan creation unit 104 to the operation plan storage 106. Then, the operation plan storage 106 stores the operation plan output from the output unit 105. The output unit 105 may display the operation plan or communicate the operation plan to an external device.

### [Hardware Configuration]

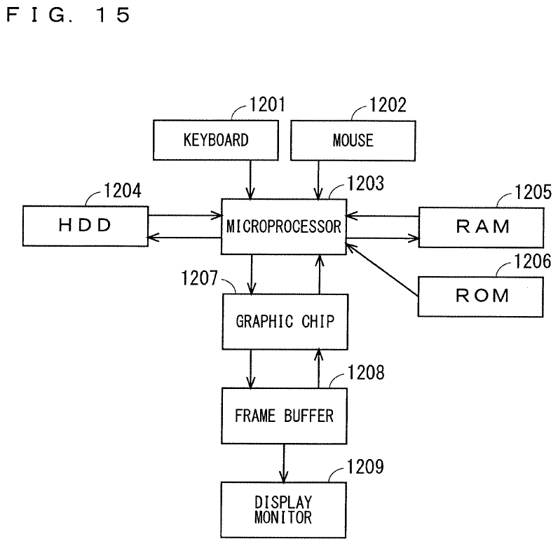

FIG. 15 is a block diagram illustrating a hardware configuration of a computer terminal for implanting the operation plan creation apparatus 101 according to Embodiment 1. The computer of FIG. 15 includes a keyboard 1201, a mouse 1202, a microprocessor 1203, a hard disc drive (HDD) 1204, random-access memory (RAM) 1205, read-only memory (ROM) 1206, a graphic chip 1207, a frame buffer 1208, and a display monitor 1209. The operator information receiver 102a, the production planning receiver 102b, the load estimator 103, the temporary operation plan creation unit 104a, and the simulator 104b are implemented through cooperation between the hardware of the microprocessor 1203, the HDD 1204, the RAM 1205, and the ROM 1206 and software such as a control program for controlling operations of the operation plan creation apparatus 101.

### [Network Configuration]

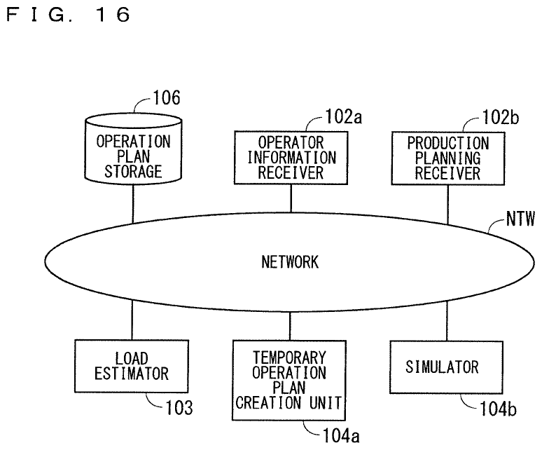

FIG. 16 illustrates a network configuration for implanting the operation plan creation apparatus 101 according to Embodiment 1. As illustrated in FIG. 16, the operator information receiver 102a, the production planning receiver 102b, the load estimator 103, the temporary operation plan creation unit 104a, and the simulator 104b may be connected through an external network NTW.

### [Applications]

The following will describe an example where a factory manager creates an operation plan for one month (the first to the fourth weeks of November) using the operation plan creation apparatus 101. The target operation plan is an operation plan for producing a product X in the line B.

The operator information receiver 102a obtains, from the operator information management system, pieces of the biological information and the living behavior information at work time and at non-work time of all operators who work at the factory for the past three months from the time of creating the plan. The biological information includes, for example, the heart rate variability. The operator information receiver 102a obtains pieces of the attribute information of the operators from the operator information management system.

The production planning receiver 102b obtains, from the production planning creation system, a production plan for the first to the fourth weeks of November that is a time period for the operation plan.

The load estimator 103 estimates a stress level of each of the operators, based on the heart rate variability and the living behavior information at work time and at non-work time. For example, the load estimator 103 estimates a stress level when the R-R interval of the heart rate variability is more than or equal to 1000 to be “the stress level 0”, estimates a stress level when the R-R interval is more than or equal to 900 and less than 1000 to be “the stress level 1”, estimates a stress level when the R-R interval is more than or equal to 800 and less than 900 to be “the stress level 2”, and estimates a stress level when the R-R interval is less than 800 to be “the stress level 3”.

For example, the load estimator 103 calculates a monthly stress level that is a stress level per month. Next, when the monthly stress level increases or does not vary for three consecutive months, the load estimator 103 determines a monthly stress level for the latest one month to be a stress level per three months. When the monthly stress level does not increase and varies for three consecutive months, the load estimator 103 determines an average of monthly stress levels for the three months (drops the fractional portion of the number) to be a stress level per three months.

Consequently, when estimating the stress levels of the operator W003 three months, two months, and one months before the time of creating the plan to be “the stress level 0”, “the stress level 0”, and “the stress level 1”, respectively, the load estimator 103 determines “the stress level 1” for the operator W003. When estimating the stress levels of the operator W004 three months, two months, and one months before the time of creating the plan to be “the stress level 2”, “the stress level 0”, and “the stress level 0”, respectively, the load estimator 103 determines “the stress level 1” for the operator W004.

The temporary operation plan creation unit 104a creates a temporary operation plan of the operators, based on the pieces of the attribute information of the operators and the production planning. The line B in FIG. 12 includes “picking”, “assembly”, “inspection”, and “packaging” as operations. The temporary operation plan creation unit 104a first assigns the operations of the production planning to operators from among operators who plans to work on Monday in the first week of November in a time period of the operation plan, based on the pieces of the attribute information of the operators. For example, when the proficiencies of the operator W001, the operator W002, the operator W003, and the operator W004 in “assembly”, “picking”, “inspection”, and “packaging”, respectively, are high, the temporary operation plan creation unit 104a obtains the assignment of the operations on Monday as illustrated in FIG. 12. The temporary operation plan creation unit 104a assigns the operations for Tuesday and afterward in this manner to create the temporary operation plan as illustrated in FIG. 12.

The simulator 104b performs a simulation for calculating the transitions in cumulative amounts of stress levels as illustrated in FIG. 14, based on the stress levels estimated by the load estimator 103 and the temporary operation plan created by the temporary operation plan creation unit 104a.

When the cumulative amounts in the transitions of one of the operators are higher than or equal to the first threshold, the simulator 104b changes the temporary operation plan from when the cumulative amounts in the transitions are higher than or equal to the second threshold to the end of the temporary operation plan to create an operation plan. Assume a case, for example, where the first threshold is set to “2”, the second threshold is set to “1.5”, an increment of a stress level associated in advance with “inspection” is “0.2” as illustrated in FIG. 13, and “inspection” is assigned to the operator W001 for the whole time period of the operation plan. Here, the cumulative amounts of stress levels on Friday in the second week of November are “2” (=10 days×0.2) that is higher than or equal to the first threshold. The cumulative amounts of stress levels on Wednesday in the second week of November are “1.6” (=8 days×0.2) that is higher than or equal to the second threshold. Thus, the simulator 104b changes the temporary operation plan by changing the assignment of operations to the operators on Wednesday in the second week of November and afterward.

For example, the simulator 104b changes an operation from Wednesday in the second week of November to the last day of the plan (on Friday in the fourth week of November) of the operator W001 whose cumulative amounts of stress levels are higher than or equal to “2” that is the first threshold to an operation with a relatively small increment of the stress level. The operations with relatively small increments of the stress levels are “picking” and “packaging” as the operations in the line B in FIG. 13. According to the attribute information in FIG. 4, the proficiency of the operator W001 in “packaging” is higher than that in “picking”. In this case, the simulator 104b changes the temporary operation plan so that operation of the operator W001 on Wednesday in the second week of November and afterward becomes “packaging” as much as possible.

Then, the simulator 104b assigns the remaining operations during a time period from Wednesday in the second week of November to the last day of the plan to the remaining operators, based on the pieces of attribute information on the remaining operators. Here, when there is no operator who can perform “inspection” that the operator W001 is in charge of in the temporary operation plan, the simulator 104b assigns “inspection” to the operator with the longest length of service from among the operators other than the operator W001. When the aforementioned re-simulation is performed on Wednesday in the second week of November and afterward and there is no operator whose cumulative amounts are higher than or equal to “2” that is the first threshold, the simulator 104b finalizes the temporary operation plan at this time as an operation plan.

The output unit 105 outputs the operation plan created by the operation plan creation unit 104 to the operation plan storage 106. Then, the operation plan storage 106 stores the operation plan output from the output unit 105.

### Summary of Embodiment 1

The operation plan creation apparatus 101 according to Embodiment 1 estimates a stress level of an operator, based on the biological information and the living behavior information of the operator at work time and at non-work time, and creates an operation plan of the operator, based on the attribute information of the operator, the production planning on the operator, and the stress level of the operator. With such a structure, the operation plan creation apparatus 101 creates the operation plan in consideration of not only the stress level at work time but also the stress level at non-work time, for example, in daily life. This can reduce a probability of assigning an operation with a large increment of fatigue to an operator with low fatigue by chance at work time, despite the fact that the fatigue of the operator at non-work time is high. Thus, the operation plan creation apparatus 101 can create an appropriate operation plan.

The operation plan creation apparatus 101 according to Embodiment 1 calculates transitions in cumulative amounts of stress levels, based on the stress levels and an increment of each of the stress levels that are associated in advance with the operations planned in the temporary operation plan. Since the operation plan creation apparatus 101 with such a structure can set an increment of a stress level appropriate for each operation, the operation plan creation apparatus 101 can appropriately calculate the transitions in cumulative amounts of stress levels.

When the cumulative amounts in the transitions are higher than or equal to the first threshold, the operation plan creation apparatus 101 according to Embodiment 1 changes the temporary operation plan at and after time in the temporary operation plan when the cumulative amounts in the transitions are higher than or equal to the second threshold. Such a structure can suppress changes in the temporary operation plan when the cumulative amounts are higher than or equal to the first threshold at the final phase of the temporary operation plan. Thus, reduction in the processes of creating an operation plan can be expected.

### Modifications

The simulator 104b according to Embodiment 1 continues to add an increment of a stress level which is associated in advance with an operation for each day of a week while maintaining the stress level estimated by the load estimator 103 as it is, to calculate transitions in cumulative amounts of the stress levels. In other words, the simulator 104b uses, but not limited to, the stress level estimated by the load estimator 103 as an initial value of the transitions as it is. For example, the simulator 104b may change the stress level estimated by the load estimator 103, based on a time period between when the wearable device has obtained the biological information and the living behavior information and the time of the operation plan, and use the changed stress level as an initial value of the transitions.

In Applications of Embodiment 1, a cumulative amount on Monday is, but not limited to, obtained by adding an increment associated in advance with an operation on Monday to a cumulative amount on Friday in the previous week of that Monday. For example, assuming that the stress level of the operator on weekends such as Saturday and Sunday is to be reduced, the simulator 104b may reduce the cumulative amount on Friday to be used as the cumulative amount on Monday.

Modifications described above may be applied to Embodiment 2 and afterward.

### Embodiment 2

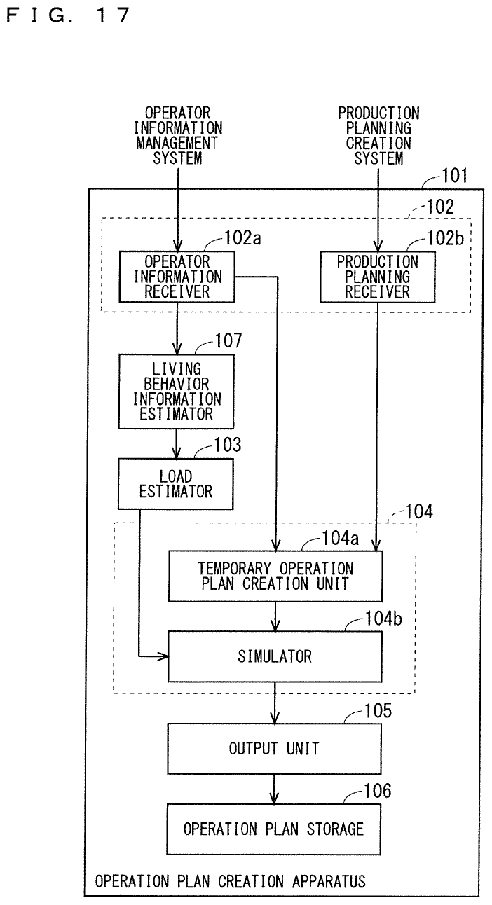

FIG. 17 is a block diagram illustrating a configuration of the operation plan creation apparatus 101 according to Embodiment 2. Among constituent elements according to Embodiment 2, the constituent elements identical or similar to those described above will be denoted by the identical or similar reference numerals, and different constituent elements will be hereinafter mainly described. The configuration of FIG. 17 is identical to a configuration to which a living behavior information estimator 107 has been added to the structure in FIG. 1.

In the presence of a time period during which the biological information to be used for estimating a stress level by the load estimator 103 is lost, the load estimator 103 according to Embodiment 1 estimates the stress level based on the biological information, and the living behavior information during the time period.

In contrast, in the presence of a time period during which the living behavior information to be used for estimating a stress level by the load estimator 103 is lost, the operation plan creation apparatus 101 according to Embodiment 2 estimates the stress level based on the living behavior information and the living behavior information during the time period.

In the presence of a time period during which the living behavior information to be used for estimating a stress level by the load estimator 103 is lost, for example, the living behavior information estimator 107 according to Embodiment 2 estimates the living behavior information during the time period, based on the biological information during the time period. Then, the living behavior information estimator 107 corrects the living behavior information based on a result of the estimation. Then, the load estimator 103 estimates the stress level, based on the living behavior information corrected by the living behavior information estimator 107.

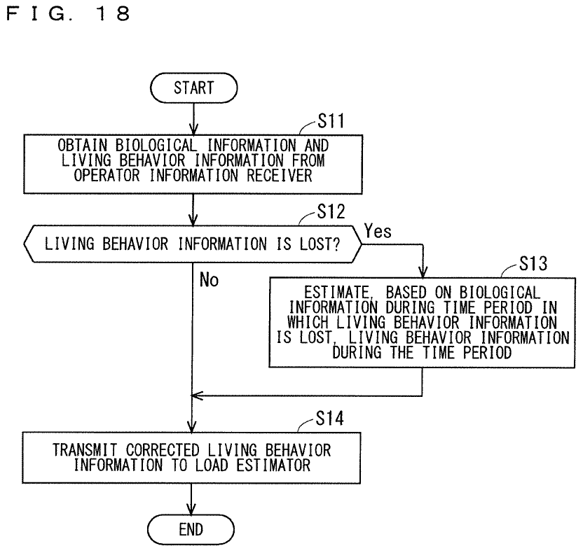

FIG. 18 is a flowchart illustrating a procedure for correcting the living behavior information by the living behavior information estimator 107 according to Embodiment 2.

First, in Step S11, the living behavior information estimator 107 obtains the biological information and the living behavior information from the operator information receiver 102a.

In Step S12, the living behavior information estimator 107 determines whether the living behavior information is lost. When determining that the living behavior information is lost, the processes proceed to Step S13. When determining that the living behavior information is not lost, the processes proceed to Step S14.

In Step S13, the living behavior information estimator 107 estimates, based on the biological information during a time period in which the living behavior information is lost, the living behavior information during the time period. The living behavior information estimator 107 estimates the living behavior information during the time period in which the living behavior information is lost, for example, using sensor information on physical motions such as an acceleration and a three-dimensional acceleration included in the biological information. Then, the processes proceed to Step S14.

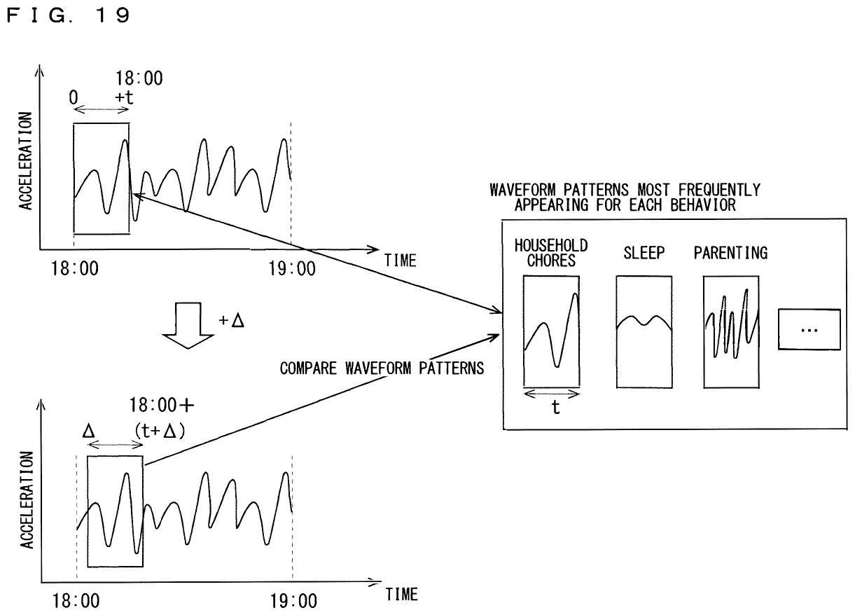

FIG. 19 illustrates an example where the living behavior information estimator 107 estimates the living behavior information during a time period in which the living behavior information is lost, using the sensor information on the acceleration.

As illustrated in FIG. 19, the living behavior information estimator 107, for example, marks off waveform patterns of the acceleration during a time period “18:00 to 19:00” with a time interval t to estimate the living behavior information during the time period. The living behavior information estimator 107 marks off the waveform patterns from “18:00” to “18:00+t”, marks off the waveform patterns from “18:00+Δ” to “18:00+(t+Δ)”, and marks off the waveform patterns from “18:00+2Δ” to “18:00+(t+2Δ)”. The living behavior information estimator 107 shifts a time interval with which the waveform patterns are marked off by “+Δ” in a time direction, and finally marks off the waveform patterns from “19:00−t” to “19:00”. The shifting time A can be arbitrarily set within a range of not exceeding the time interval t that marks off the waveform patterns. For example, when t=5 minutes, Δ is set to 1 minute that is a time within a range not exceeding 5 minutes.

The living behavior information estimator 107 defines, in advance, waveform patterns the most frequently appearing within the time interval t for each of the histories (types) of the living behaviors such as “household chores”, “sleep”, and “parenting”, and calculates a similarity between the waveform patterns of each of the marked off sections and the defined waveform patterns. The living behavior information estimator 107 calculates the similarity in waveform patterns, for example, using a correlation coefficient, a standard deviation, and a Euclidean distance between the waveform patterns of the sections and the waveform patterns defined for each living behavior information.

The living behavior information estimator 107 extracts waveform patterns the most similar to, that is, having the highest similarity with the waveform patterns of the marked off sections from among the defined waveform patterns. The living behavior information estimator 107 estimates a history (type) of the living behavior defined for the extracted waveform patterns to be a history (type) of a living behavior in the section to estimate the living behavior information during the time period in which the living behavior information is lost.

The time interval t that marks off the waveform patterns is, but not limited to, constant, irrespective of the living behavior information to be compared in the aforementioned example. For example, the time interval t of the waveform patterns may be changed to a longer time interval or a shorter time interval for each living behavior information to be compared. When the number of pieces of data differs, for example, a correlation coefficient and a standard deviation cannot be calculated. In such a case, the living behavior information estimator 107 may apply the Fourier transform to the waveform patterns of each of the sections and the defined waveform patterns, and compare frequency spectrums obtained through the Fourier transform to estimate the living behavior information during the time period in which the living behavior information is lost.

The living behavior information estimator 107 may narrow down the waveform patterns defined for each living behavior information to the waveform patterns to be used for estimating the living behavior information, for example, based on position information of an operator. For example, when the position information of the operator during “18:00 to 19:00” indicates outside home, the probability that “household chores” are determined as a history of the living behavior in the section is sufficiently low. Thus, the living behavior information estimator 107 may exclude the waveform patterns defined for “household chores” from the waveform patterns to be used for estimating the living behavior information in the section.

In Step S14 of FIG. 18, the living behavior information estimator 107 corrects the living behavior information based on a result of the estimation. Then, the living behavior information estimator 107 transmits the corrected living behavior information to the load estimator 103. Thereby, the load estimator 103 estimates the stress level, based on the corrected living behavior information.

### Summary of Embodiment 2

Even when the living behavior information is lost, the operation plan creation apparatus 101 according to Embodiment 2 can reduce losses in estimating the stress level. This is particularly effective because the living behavior information is probably lost due to, for example, an input omission in a structure where its own operator records the living behavior information through electronic equipment such as a smart phone.

### Embodiment 3

A block diagram illustrating a configuration of the operation plan creation apparatus 101 according to Embodiment 3 is identical to those according to Embodiments 1 and 2. Among constituent elements according to Embodiment 3, the constituent elements identical or similar to those described above will be denoted by the identical or similar reference numerals, and different constituent elements will be hereinafter mainly described.

The simulator 104b according to Embodiment 3 obtains production facility information from a production management system.

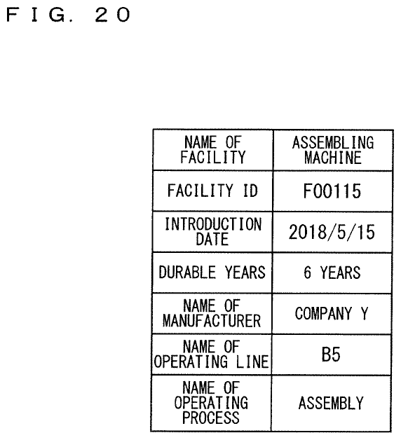

FIG. 20 illustrates an example of the production facility information. The production facility information is information on facilities to be used for operations for manufacturing products in a factory (i.e., operations to be planned in a temporary operation plan). Examples of the facilities include assembling machines and robots for assembling parts, transport machines that transport parts between processes, and inspection equipment that inspects external states of products, using cameras. Examples of the production facility information include names of the facilities, facility IDs for identifying the production facilities, introduction dates, durable years, names of manufacturers, names of operating lines each indicating in which production line the facility is operating, and names of operating processes each indicating in which process (operation) in line the facility is to be used.

According to Embodiment 1, an increment of a stress level is associated in advance with each operation planned in a temporary operation plan as illustrated in FIG. 13, without consideration of the production facilities. In contrast, the simulator 104b according to Embodiment 3 changes the increment of the stress level which is associated in advance with each operation planned in the temporary operation plan, based on the production facility information.

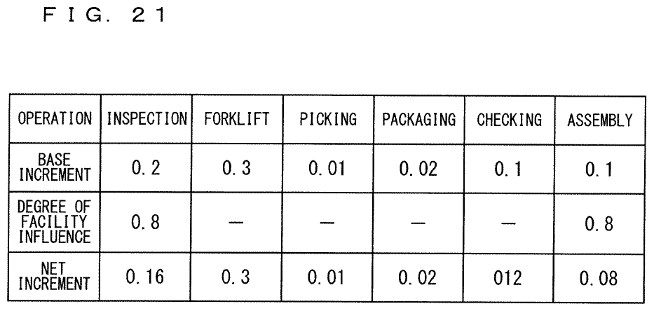

For example, when new facilities such as an assembling robot and inspection equipment are introduced to an assembly process and an inspection process, respectively, increments of stress levels in performing the operations are probably reduced more than those before introducing the facilities. In consideration of these influences, for example, the simulator 104b determines at least one of a degree of a facility influence indicating an influence of the production facility or the influence of the production facility, based on the production facility information as illustrated in FIG. 21, and changes the increments of the stress levels based on the at least one of these. The simulator 104b may multiply a base increment in FIG. 21 (corresponding to the increment of the stress level in FIG. 13) by a degree of a facility influence having a value lower than 1 to calculate a net increment, and perform a simulation using the calculated net increment.

The simulator 104b may change the degree of the facility influence, based on the number of usage years with respect to the durable years of a production facility. For example, when the production facility has been used for the number of years (e.g., 6 years) exceeding the durable years of the production facility (e.g., 5 years), a short time breakdown may occur due to, for example, a trouble or a malfunction in the production facility which may increase the stress levels of the operators. Thus, the simulator 104b may multiply the base increment of an operation using such a facility in FIG. 21 by a degree of a facility influence having a value larger than 1 to calculate a net increment, and perform a simulation using the calculated net increment. The degree of facility influence may be reviewed when a production facility is newly introduced, updated, or abandoned, or may be regularly reviewed.

### Summary of Embodiment 3

The operation plan creation apparatus 101 according to Embodiment 3 changes an increment associated in advance with each operation, based on information on a facility to be used for the operation. Since the operation plan creation apparatus 101 with such a structure can consider a facility influence, the operation plan creation apparatus 101 can appropriately calculate transitions in cumulative amounts of stress levels.

Embodiments and the modifications can be freely combined, and appropriately modified or omitted.

The foregoing description is in all aspects illustrative, and is not restrictive. Therefore, numerous modifications and variations that have not yet been exemplified are devised.

### EXPLANATION OF REFERENCE SIGNS

101 operation plan creation apparatus, 102 obtaining unit, 103 load estimator, 104 operation plan creation unit, 104a temporary operation plan creation unit, 104b simulator, 105 output unit.

1. An operation plan creation apparatus, comprising:
obtaining circuitry to obtain biological information and living behavior information of an operator at work time and at non-work time, attribute information on the operator, and production planning on the operator;
a load estimator to estimate a mental load amount on the operator by comparing, with a threshold, the biological information excluding the biological information of a time period during which a behavior predefined in the living behavior information has been performed;
temporary operation plan creation circuitry to create a temporary operation plan of the operator, based on the attribute information and the production planning; and
a simulator to add, to the mental load amount an increment of the mental load amount which is associated in advance with an operation to be planned in the temporary operation plan to calculate a cumulative amount of the mental load amount, and change the temporary operation plan based on the cumulative amount to create an operation plan of the operator.

2. The operation plan creation apparatus according to claim 1, further comprising
output circuitry to output the operation plan created by the simulator.

3.-4. (canceled)

5. The operation plan creation apparatus according to claim 1,
wherein the simulator changes the increment associated in advance with the operation, based on information on a facility to be used for the operation to be planned in the temporary operation plan.

6. The operation plan creation apparatus according to claim 1,
wherein the simulator changes the temporary operation plan when the cumulative amount is higher than or equal to a first threshold.

7. The operation plan creation apparatus according to claim 6,
wherein when the cumulative amount is higher than or equal to the first threshold, the simulator changes the temporary operation plan at and after time in the temporary operation plan when the cumulative amount is higher than or equal to a second threshold lower than the first threshold.

8. The operation plan creation apparatus according to claim 1,
wherein the load estimator estimates the mental load amount during a period identical in length to the production planning.

9. The operation plan creation apparatus according to claim 1,
wherein in the presence of a time period during which one of the biological information and the living behavior information to be used for estimating the mental load amount by the load estimator is lost, the load estimator estimates the mental load amount based on the one of the biological information and the living behavior information, and the other of the biological information and the living behavior information during the time period.

10. An operation plan creation method, comprising:
obtaining biological information and living behavior information of an operator at work time and at non-work time, attribute information on the operator, and production planning on the operator, the obtaining being performed by obtaining circuitry;
estimating a mental load amount on the operator by comparing, with a threshold, the biological information excluding the biological information of a time period during which a behavior predefined in the living behavior information has been performed, the estimating being performed by a load estimator;
creating a temporary operation plan of the operator, based on the attribute information and the production planning, the creating being performed by temporary operation plan creation circuitry; and
adding, to the mental load amount, an increment of the mental load amount which is associated in advance with an operation to be planned in the temporary operation plan to calculate a cumulative amount of the mental load amount, and changing the temporary operation plan based on the cumulative amount to create an operation plan of the operator, the adding and the changing being performed by a simulator.

11. The operation plan creation apparatus according to claim 2,
wherein the simulator changes the increment associated in advance with the operation, based on information on a facility to be used for the operation to be planned in the temporary operation plan.

12. The o ration plan creation apparatus according to claim 2,
wherein the simulator changes the temporary operation plan when the cumulative amount is higher than or equal to a first threshold.

13. The operation plan creation apparatus according to claim 2,
wherein the load estimator estimates the mental load amount during a period identical in length to the production planning.

14. The operation plan creation apparatus according to claim 2,
wherein in the presence of a time period during which one of the biological information and the living behavior information to be used for estimating the mental load amount by the load estimator is lost, the load estimator estimates the mental load amount based on the one of the biological information and the living behavior information, and the other of the biological information and the living behavior information during the time period.
